(19) United States
(12) Patent Application Publication
(10) Pub. No.: US 2025/0149658 A1
(43) Pub. Date: May 8, 2025

(54) APPARATUS FOR MANAGING BATTERY, SYSTEM INCLUDING SAME AND METHOD THEREOF

(71) Applicants: Hyundai Motor Company, Seoul (KR); Kia Corporation, Seoul (KR); Sogang University Research & Business Development Foundation, Seoul (KR)

(72) Inventors: Jae Hyuk Choi, Hwaseong-si (KR); Soo Yong Park, Seoul (KR); Si Woo Seong, Seoul (KR); Jung Won Seo, Seoul (KR)

(21) Appl. No.: 18/917,673

(22) Filed: Oct. 16, 2024

(30) Foreign Application Priority Data
Nov. 2, 2023 (KR) 10-2023-0150356

(51) Int. Cl. H01M 10/42; H01M 10/48

(52) U.S. Cl. CPC H01M 10/425; H01M 10/48; H01M 2010/4271; H01M 2010/4278; H01M 2220/20

(57) ABSTRACT

A battery management apparatus, a system including the same, and a method thereof, can include one or more processors, a storage medium storing computer-readable instructions that, when executed by the one or more processors, enable the one or more processors to extract a target record including a usage or management record related to a battery for a vehicle, encrypt the target record when the battery does not meet battery performance for operating the vehicle, and sell the encrypted target record, which can be used in whole or in part as a basis for determining whether to reuse the battery, to an external server.

### CROSS-REFERENCE TO RELATED APPLICATIONS

This application claims the benefit of Korean Patent Application No. 10-2023-0150356,filed on Nov. 2, 2023, which application is hereby incorporated herein by reference.

### TECHNICAL FIELD

The present disclosure relates to a battery management system.

### BACKGROUND

Recently, as the size of the electric vehicle market gradually expands, interest in the recycling market for batteries used in electric vehicles has increased. However, because there are no management methods and certification standards for batteries used in electric vehicles, it is difficult to revitalize the battery recycling market.

To revitalize the battery recycling market, as the Web 3.0 market and the electric vehicle market gradually grow, the Drive-to-Earn (D2E) market, which may combine the two fields, attracts attention as an opportunity to create new business. For example, Web 3.0 refers to a platform that allows users to manage and control the data the users create by guaranteeing the sovereignty of the data the users create. In this regard, investment in Web 3.0 has increased globally. In particular, with regard to Web 3.0 and the electric vehicle market, there is an increasing trend of attempts to apply blockchain technology to the Web 3.0 market as a future core technology.

The D2E (Drive to Earn), which is derived from P2E (Play to Earn), can refer to income that may be earned through specific activities, and that a user may earn income while driving a vehicle. In detail, the number of vehicles capable of performing D2E is confirmed to be 1.446 billion as of 2022, and the potential market value of D2E is evaluated to be quite promising.

As the size of the electric vehicle market gradually expands, interest in the recycling market of batteries used in electric vehicles has increased gradually. The electric vehicle battery recycling market is expected to grow at an average annual rate of 26% to KRW 87 trillion in 2040. Although the battery recycling market increases, it is difficult to revitalize the battery recycling market because there are no management methods and certification standards for battery recycling. Therefore, there is a need to develop technology for vehicle battery recycling.

### SUMMARY

The present disclosure relates to an apparatus for managing a battery, a system including the same, and a method thereof, and more particularly, to a technology for trading vehicle batteries.

Some embodiments of the present disclosure can solve the above-mentioned problems occurring in the prior art while advantages achieved by the prior art are maintained intact.

An embodiment of the present disclosure provides an apparatus for managing a battery capable of providing a reward to a user who sells expired batteries by encrypting records related to the vehicle batteries and sells them to an external server, promoting the revitalization of the battery reuse market and the reuse market of waste battery parts based on records about batteries, and enhancing the security of battery records through blockchain, a system including the same, and a method thereof.

An embodiment of the present disclosure provides an apparatus for managing a battery capable of solving social issues related to used battery disposal due to increased use of electric vehicles by purchasing encrypted target records and batteries together, and providing efficiency and convenience in battery inspection through battery records, a system including the same, and a method thereof.

An embodiment of the present disclosure provides an apparatus for managing a battery capable of reducing the cost of recycling battery analysis through batteries with transparent management history by receiving or purchasing batteries based on a battery being determined to be reusable, a system including the same, and a method thereof.

Technical problems solved by some embodiments of the present disclosure are not necessarily limited to the aforementioned problems, and solutions to other technical problems not mentioned herein using some embodiments of the present disclosure can be clearly understood from the following description by those skilled in the art to which the present disclosure pertains.

According to an embodiment of the present disclosure, an apparatus for managing a battery includes a memory that stores computer-executable instructions, and at least one processor that accesses the memory and execute the instructions, wherein the at least one processor may extract a target record including a usage or management record related to a battery of a vehicle from the vehicle, encrypt the target record when the battery does not meet battery performance for operating the vehicle, and sell the encrypted target record, which is used in whole or in part as a basis for determining whether to reuse the battery, to an external server.

According to an embodiment, the at least one processor may store (fetch) the target record extracted from the vehicle in a blockchain wallet, and generate a target certificate for authenticating the usage or management record related to the battery by tokenizing the target record stored in the blockchain wallet.

According to an embodiment, at least one processor may call a target function of a first standard contract to link the blockchain wallet, apply the target record to the target function of the first standard contract based on the target function of the first standard contract being called, issue a token related to the target record, and store the token related to the target record in the blockchain wallet.

According to an embodiment, the at least one processor may generate a target structure including at least one of a first factor for indicating whether the target record is verified, a second factor for recognizing the target certificate to be generated from the target record, or a third factor for an address where the target record is stored in a file system using an interplanetary file system (IPFS) protocol, or any combination thereof, and apply the target structure to a token related to the target record.

According to an embodiment, the at least one processor may calculate at least one of a usage amount of the battery, a capacity of the battery, a number of charging times of the battery, a usage time of the battery, or any combination thereof based on at least one of a voltage of the battery, a current of the battery, a temperature of the battery, or any combination thereof, apply at least one of the usage amount of the battery, the capacity of the battery, the number of charging times of the battery, the usage time of the battery, or any combination thereof, to the target record, call a target function of a second standard contract to tokenize related to the target record into a non-fungible token (NFT), and apply the target record to the target function of the second standard contract based on the target function of the second standard contract being called and generate the target certificate, wherein the usage or management record related to the battery includes at least one of the voltage of the battery, the current of the battery, the temperature of the battery, or any combination thereof, based on at least one of a charging time point of the battery, a reception time point of a user input, or any combination thereof.

According to an embodiment, the at least one processor may generate an address of the blockchain wallet and an address of a smart contract for generating the target certificate, wherein the smart contract includes content regarding an operation of storing the target record in the blockchain wallet and an operation of tokenizing the target record.

According to an embodiment of the present disclosure, a system for managing a battery includes a battery management apparatus, a first server, and a second server, where the battery management apparatus may extract a target record including a usage or management record related to a battery of a vehicle from the vehicle, encrypt the target record, and sell an encrypted target record to the first server when the battery does not meet battery performance for operating the vehicle, and the first server may purchase the encrypted target record from the battery management apparatus, or purchase the encrypted target record and the battery together, determine whether to reuse the battery based on the encrypted target record, and provide the encrypted target record for the battery determined to be reusable to the second server in response to a request from the second server.

According to an embodiment, the battery management apparatus may store (fetch) the target record extracted from the vehicle in a blockchain wallet, and generate a target certificate for authenticating the usage or management record related to the battery by tokenizing the target record stored in the blockchain wallet.

According to an embodiment, the first server may load a target address where the encrypted target record is to be stored in a file system using an interplanetary file system (IPFS) protocol, verify the usage or management record related to the battery included in the encrypted target record based on the target address, and apply the usage or management record related to the battery to a selected, set, or predetermined verification model to determine whether to reuse the battery.

According to an embodiment, the first server may call a target function of a third standard contract, and apply at least one of an address for recognizing the encrypted target record, an address for purchasing the battery, an address for a smart contract for selling the battery, or any combination thereof, to the target function of the third standard contract based on the target function of the third standard contract being called, thereby performing a sale of the battery.

According to an embodiment, the second server may receive or purchase the battery from the first server based on when the first server determines that the battery is reusable, and use or resell the battery based on the usage or management record regarding the battery.

According to an embodiment, the second server may receive or purchase a battery whose reuse is determined by the first server based on the encrypted target record without performing analysis on the battery.

According to an embodiment, the battery management apparatus may provide a set or predetermined notification to a user using the vehicle when the battery does not meet battery performance for operating the vehicle, and extract at least one target record from the vehicle based on at least one of a time point when receiving a request from the user of the vehicle, a set or predetermined time interval, or any combination thereof.

According to an embodiment, the at least one target record may be used for regular or irregular inspection of the vehicle.

According to an embodiment of the present disclosure, a method of managing a battery includes extracting, by a battery management apparatus, a target record including a usage or management record related to a battery of a vehicle from the vehicle, encrypting, by the battery management apparatus, the target record and selling an encrypted target record to a first server when the battery does not meet battery performance for operating the vehicle, purchasing, by the first server, the encrypted target record from the battery management apparatus, or purchasing the encrypted target record and the battery together, determining, by the first server, whether to reuse the battery based on the encrypted target record, providing, by the first server, the encrypted target record for the battery determined to be reusable to a second server different from the first server, providing, by the battery management apparatus, a set or predetermined notification to a user using the vehicle when the battery does not meet battery performance for operating the vehicle, and extracting, by the battery management apparatus, at least one target record from the vehicle based on at least one of a time point when receiving a request from the user of the vehicle, a set or predetermined time interval, or any combination thereof, wherein the at least one target record is used for regular or irregular inspection of the vehicle.

According to an embodiment, the method may further include storing (fetching), by the battery management apparatus, the target record extracted from the vehicle in a blockchain wallet, and generating, by the battery management apparatus, a target certificate for authenticating the usage or management record related to the battery by tokenizing the target record stored in the blockchain wallet.

According to an embodiment, the method may further include loading, by the first server, a target address where the encrypted target record is to be stored in a file system using an interplanetary file system (IPFS) protocol, verifying, by the first server, a usage or management record related to the battery included in the encrypted target record based on the target address, and applying, by the first server, a usage or management record related to the battery to a set or predetermined verification model to determine whether to reuse the battery.

According to an embodiment, the method may further include calling, by the first server, a target function of a third standard contract, and applying, by the first server, at least one of an address for recognizing the encrypted target record, an address for recognizing the second server purchasing the battery, an address of a smart contract for selling the battery, or any combination thereof, to the target function of the third standard contract based on the target function of the third standard contract being called.

According to an embodiment, the method may further include receiving or purchasing, by the second server, the battery from the first server based on when the first server determines that the battery is reusable, using or reselling, by the second server, the battery based on the usage or management record regarding the battery, and receiving or purchasing, by the second server, a battery whose reuse is determined by the first server based on the encrypted target record without performing analysis on the battery.

According to an embodiment of the present disclosure, a server for providing a battery service includes a memory configured to store computer-executable instructions, and at least one processor configured to access the memory and execute the instructions, wherein the at least one processor may obtain, from a battery management apparatus, a target record including a usage or management record related to a battery of a vehicle, the record being encrypted, verify the usage or management record related to the battery included in the encrypted target record based on a target address on a file system using an interplanetary file system (IPFS) protocol based on obtaining the encrypted target record, apply the usage or management record related to the battery to a set or predetermined verification model to determine whether to reuse the battery based on the verifying of the usage or management record related to the battery, and sell the battery corresponding to the encrypted target record based on that the battery is reusable in response to a purchase request for the battery.

### BRIEF DESCRIPTION OF THE DRAWINGS

The above and other features and advantages of the present disclosure can be more apparent from the following detailed description taken in conjunction with the accompanying drawings, in which:

FIG. 1 is a diagram illustrating a battery management apparatus according to an embodiment of the present disclosure;

FIG. 2 is a flowchart illustrating a method of managing a battery according to an embodiment of the present disclosure;

FIG. 3 is a diagram illustrating a method of selling a target certificate in a battery management apparatus according to an embodiment of the present disclosure;

FIG. 4 is a diagram illustrating a vehicle, a first server, and a second server included in a battery management system according to an embodiment of the present disclosure;

FIG. 5A is a diagram illustrating a screen for storing a target record in a blockchain wallet in a battery management apparatus according to an embodiment of the present disclosure;

FIG. 5B is a diagram illustrating a portion of a code for storing a token related to a target record of a source level that may be executed in a battery management apparatus according to an embodiment of the present disclosure in a blockchain wallet;

FIG. 5C is a diagram illustrating a portion of a code related to a target function of the first standard contract of a source level that may be executed in a battery management apparatus according to an embodiment of the present disclosure;

FIG. 5D is a diagram illustrating a portion of a code of a source-level target structure that may be executed in a battery management apparatus according to an embodiment of the present disclosure;

FIG. 6A is a diagram illustrating a screen for generating a target certificate from a target record in a battery management apparatus according to an embodiment of the present disclosure;

FIG. 6B is a diagram illustrating a portion of a code for generating a target certificate from a target record of a source level that may be executed in a battery management apparatus according to an embodiment of the present disclosure;

FIG. 7 is a diagram illustrating a screen showing a result of generating a target certificate in a battery management apparatus according to an embodiment of the present disclosure;

FIG. 8 is a diagram illustrating a screen displaying at least one target certificate in a battery management apparatus according to an embodiment of the present disclosure;

FIG. 9A is a diagram illustrating a screen for verifying a usage or management record of a battery in a first server included in a battery management system according to an embodiment of the present disclosure;

FIG. 9B is a diagram illustrating a portion of a code for verifying a target certificate of a source level that may be executed on a first server included in a battery management system according to an embodiment of the present disclosure;

FIG. 9C is a diagram illustrating a portion of a code for completing verification of a target certificate of a source level that may be executed on a first server included in a battery management system according to an embodiment of the present disclosure;

FIG. 10A is a diagram illustrating a screen for purchasing a battery from a battery management apparatus in a first server included in a battery management system according to an embodiment of the present disclosure;

FIG. 10B is a diagram illustrating a portion of a code for purchasing a target certificate of a source-level that may be executed on a first server included in a battery management system according to an embodiment of the present disclosure;

FIG. 11 is a diagram illustrating a screen showing a result of purchasing a battery from a battery management apparatus in a first server included in a battery management system according to an embodiment of the present disclosure; and

FIG. 12 is a diagram illustrating a computing system related to a battery management apparatus, a system including the same, and a method thereof according to embodiments of the present disclosure.

Regarding the description of drawings, the same or similar elements may be marked by the same or similar reference numerals.

### DETAILED DESCRIPTION OF ILLUSTRATIVE EMBODIMENTS

Hereinafter, some embodiments of the present disclosure will be described in detail with reference to the example drawings. In adding the reference numerals to the components of each drawing, identical or equivalent component can be designated by the identical numeral even when they are displayed on other drawings. Further, in describing some embodiments of the present disclosure, a detailed description of related known configurations or functions can be omitted if it may interfere with the understanding of the embodiment of the present disclosure. Various embodiments of the present disclosure may be described with reference to accompanying drawings. Accordingly, those of ordinary skill in the art can recognize that modifications, equivalents, and/or alternatives on the various embodiments described herein may be variously made without departing from the scope and spirit of the present disclosure. With regard to description of drawings, similar elements may be marked by similar reference numerals.

Terms, such as “first”, “second”, “A”, “B”, “(a)”, “(b)”, or the like, may be used herein when describing components of the present disclosure. Such terms can be provided merely to distinguish the elements from other elements, and the essences, sequences, orders, and numbers of the elements are not necessarily limited by such terms. For example, “a first user device” and “a second user device” can indicate different user devices regardless of the order or priority. For example, without departing the scope of the present disclosure, a first element may be referred to as a second element, and similarly, a second element may be referred to as a first element.

In the present disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

It can be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it can be understood that there are no intervening element (e.g., a third element).

According to the situation, the expression “configured to” used herein may be used as, for example, the expression “suitable for”, “having the capacity to”, “designed to”, “adapted to”, “made to”, or “capable of”.

The term “configured to” is not necessarily limited to being only “specifically designed to” in hardware. Instead, the expression “a device configured to” may mean that the device is “capable of” operating together with another device or other components. For example, a “processor configured to perform A, B, and C” may mean a dedicated processor (e.g., an embedded processor) for performing a corresponding operation or a generic-purpose processor (e.g., a central processing unit (CPU) or an application processor) that may perform corresponding operations by executing one or more software programs that are stored in a memory device. Terms used in this disclosure can be used to describe specified embodiments of the present disclosure and are not intended to limit the scope of the present disclosure. The terms of a singular form may include plural forms unless otherwise specified. Terms used herein, which include technical or scientific terms, can have a same meaning that is generally understood by a person skilled in the art. Terms that are defined in a dictionary and commonly used, can be also be interpreted as is customary in the relevant related art. In some cases, even when terms are defined in the present disclosure, they may not be interpreted to exclude embodiments of the present disclosure.

In the present disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to any or all of the cases wherein (1) at least one A is included, (2) at least one B is included, or (3) both of at least one A and at least one B are included. In addition, as used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. In particular, a phrase such as “at least one of A, B, C, or any combination thereof” may include A or B or C or any combination thereof such as AB or ABC.

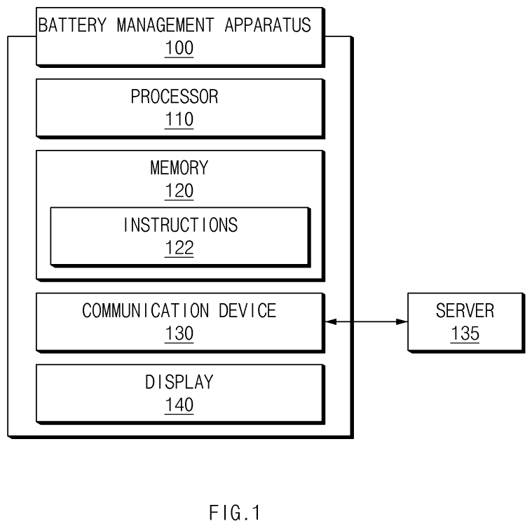

Hereinafter, some embodiments of the present disclosure will be described in detail with reference to FIGS. 1 to 12.

FIG. 1 is a diagram illustrating a battery management apparatus according to an embodiment of the present disclosure.

A battery management apparatus 100 according to an embodiment may include a processor 110, a memory 120 including instructions 122, a communication device 130, and a display 140, any combination of or all of which may be in plural or may include plural components thereof.

The battery management apparatus 100 may represent a battery management apparatus that generates an encrypted target record that is used in whole or in part as a basis for determining whether a battery is reusable. For example, the battery management apparatus 100 may extract a target record including information about a battery recorded in a vehicle. The battery management apparatus 100 may extract a target record including usage or management records related to the vehicle battery from the vehicle. The target record may include history generated while the vehicle user uses or manages the vehicle battery. In relation to extracting a target record from a vehicle, the battery management apparatus 100 may extract at least one target record from the vehicle based on at least one of a time point of receiving a request from the vehicle user, a set or predetermined time interval, or any combination thereof.

The usage or management record of the battery may include at least one of a voltage of the battery, a current of the battery, a temperature of the battery, or any combination thereof, based on at least one of a time point of charging the battery, a time point of receiving a user input, or any combination thereof.

The vehicle user may periodically record at least one of voltage, current, temperature of the battery, or any combination thereof, which can be a usage or management record related to the battery, in the vehicle. However, the scheme of recording at least one of voltage, current, temperature of the battery, or any combination thereof, which can be a usage or management record of a battery, in the vehicle, is not necessarily limited to thereto. For example, when the battery of the vehicle is in a charging state, the battery management apparatus 100 may periodically record at least one of the voltage, current, temperature of the battery, or any combination thereof, which can be a usage or management record related to the battery, in the vehicle.

The vehicle user may efficiently check or manage the battery of the vehicle by recording at least one of the voltage, current, temperature of the battery, or any combination thereof, which can be a usage or management record of the battery, in the vehicle. Therefore, at least one target record stored in the vehicle may be used for regular or irregular inspection of the vehicle. As will be described later, the target record including the usage or management record related to the battery recorded in the vehicle may be encrypted and provided to an external server 135. By providing the encrypted target record to the external server 135 through the battery management apparatus 100, the vehicle user may receive an additional reward from the server 135 through the sale of an expired battery.

The battery management apparatus 100 may encrypt the above-described target record based on the performance of the battery. For example, the battery management apparatus 100 may encrypt the target record based on when the battery does not meet the battery performance for operating the vehicle (e.g., when the battery life is complete or selected as completed). Regarding the encryption scheme, the battery management apparatus 100 may encrypt the target record by using an encryption key obtained according to a preset encryption scheme. In detail, the battery management apparatus 100 may encrypt the target record by using an encryption key based on at least one of vehicle user information, battery information, or information about battery performance, or any combination thereof. However, a scheme of encrypting a target record is not limited to the above. For example, the battery management apparatus 100 may generate an encrypted target record by converting the target record into a non-fungible token (NFT). The detailed scheme of converting a target record into an NFT will be described later.

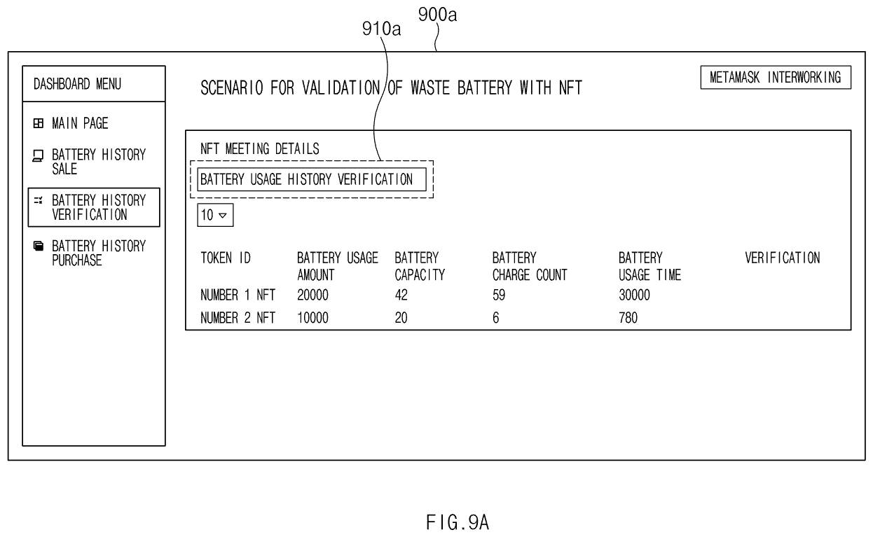

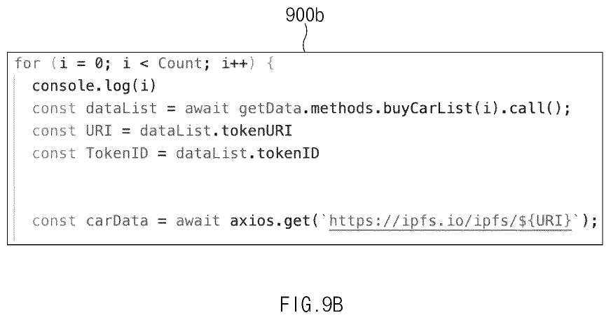

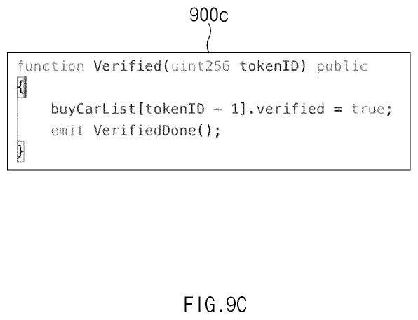

The battery management apparatus 100 may sell the encrypted target record to the external server 135. For example, the battery management apparatus 100 may provide the encrypted target record to the server 135 through the communication device 130. The battery management apparatus 100 may sell the encrypted target record by providing the encrypted target record to the server 135. The encrypted target record provided from the battery management apparatus 100 to the server 135 may be used in whole or in part as the basis for determining whether to reuse the battery by the server 135. The details will be described later with reference to FIGS. 9A to 9C.

The processor 110 may execute software and control at least another component (e.g., a hardware or software component) connected to the processor 110. The processor 110 may also perform various data processing or operations. For example, the processor 110 may store the target record, the encrypted target record, and the target certificate in the memory 120.

For reference, the processor 110 may perform, control, or drive all operations performed by the battery management apparatus 100. Therefore, for convenience of explanation, in this specification, operations performed by the battery management apparatus 100 are mainly described as operations performed by the processor 110 (which can include controlling, driving, initiating, or prompting, for example). In addition, in this specification, for convenience of explanation, the processor 110 is mainly described as being a single processor, but an embodiment is not necessarily limited thereto. For example, the battery management apparatus 100 may include at least one processor. Each of the at least one processor may perform all operations related to an operation of generating an encrypted target record that is used in whole or in part as the basis for determining whether to reuse the battery.

The memory 120 may temporarily and/or permanently store various data and/or information required to perform an operation of generating an encrypted target record that is used in whole or in part as the basis for determining whether to reuse the battery. For example, the memory 120 may store a target record, an encrypted target record, and a target certificate.

The communication device 130 may support communication between the battery management apparatus 100 and the server 135. For example, the communication device 130 may include at least one component that enables communication between the battery management apparatus 100 and the server 135. For example, the communication device 130 may include a short range wireless communication device, a microphone, and the like. For example, short-range communication technologies can include wireless LAN (Wi-Fi), Bluetooth, ZigBee, Wi-Fi direct (WFD), ultra-wideband (UWB), infrared data association (IrDA), Bluetooth low energy (BLE), near field communication (NFC), and the like, but an embodiment is not necessarily limited thereto.

The server 135 may purchase an encrypted target record from a battery management apparatus, or purchase an encrypted target record and a battery together. The server 135 may determine whether to reuse the battery based on the encrypted target record. The server 135 may provide records relating to the battery purchased from the battery management apparatus to a server (e.g., a second server) different from the server 135 based on it being determined that the battery is reusable.

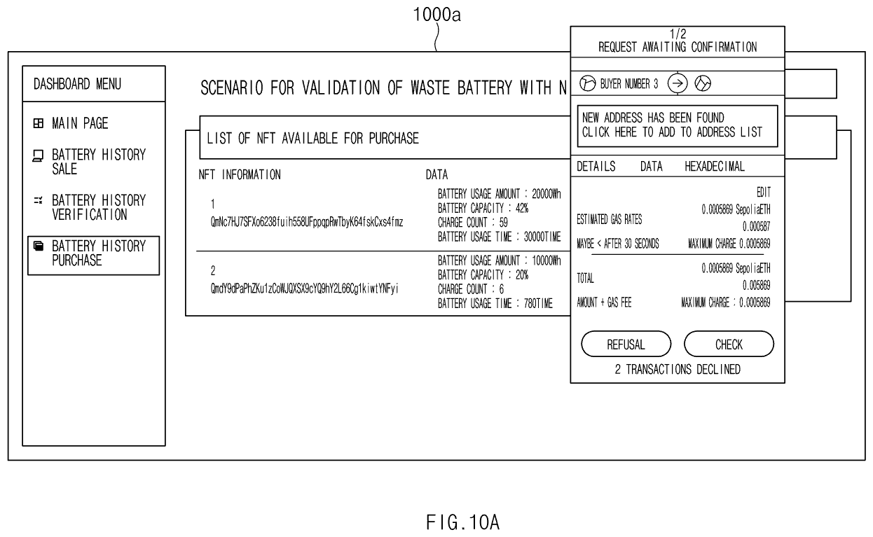

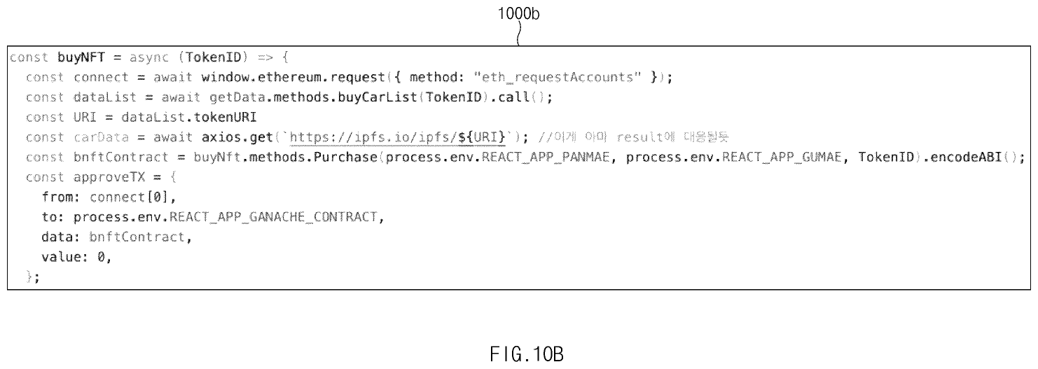

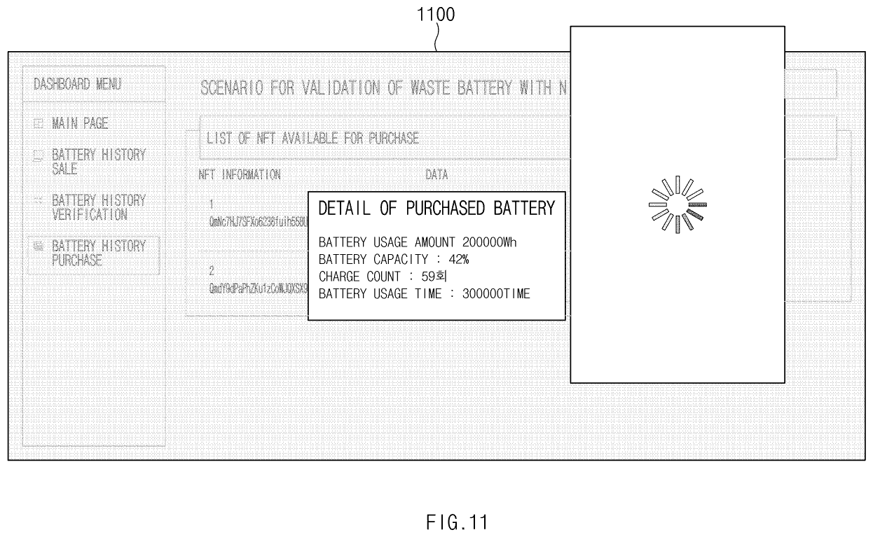

The server 135 may determine whether to reuse or disassemble the battery based on the encrypted target record, based on the encrypted target record being purchased or the encrypted target record and the battery are purchased together. The server 135 may provide records relating to the battery to the second server different from the server 135 based on it being determined that the battery purchased from the battery management apparatus 100 is reusable. To the contrary, the server 135 may prompt for disassembling the battery based on it being determined that the battery purchased from the battery management apparatus 100 may not be reused. The server 135 may purchase at least one of an encrypted target record, or a battery related to the target record, or any combination thereof, determine whether to reuse the purchased target, and generate a battery management business model related to battery reuse and reuse of waste battery parts. In this regard, detailed operations of the server 135 will be described later with reference to FIGS. 10A to 10B and FIG. 11.

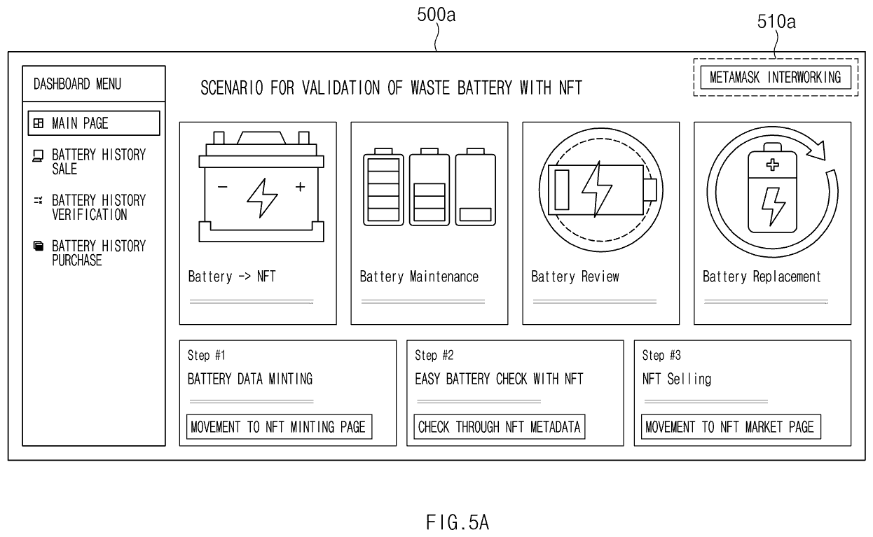

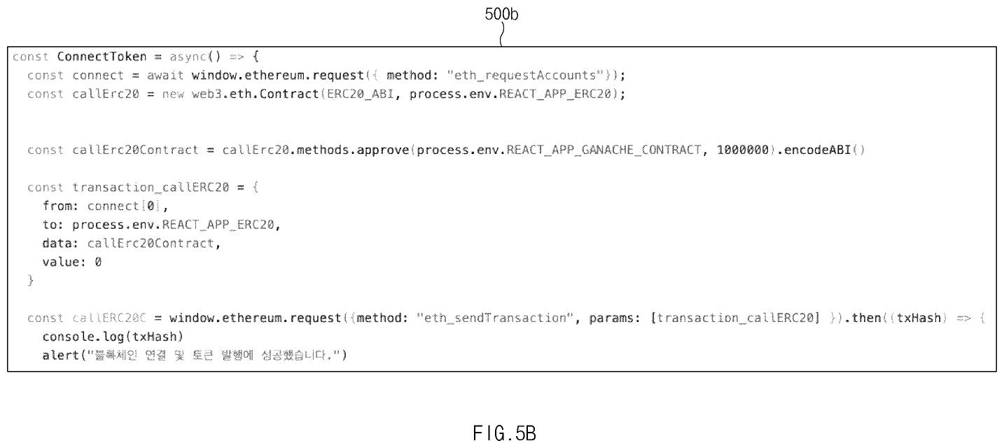

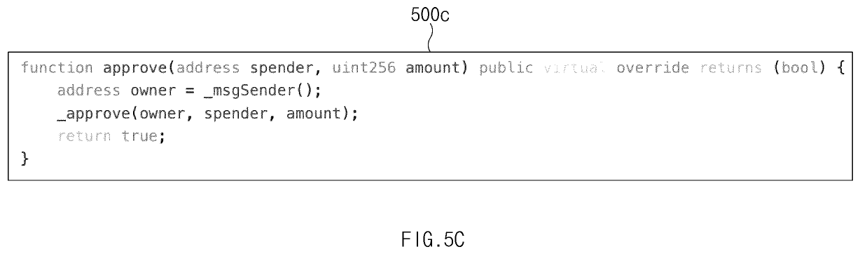

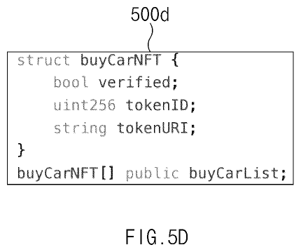

Based on the control of the processor 110, the display 140 may provide a screen interface that outputs images for battery reuse, such as by arranging the images not to overlap. For example, based on the control of the processor 110, the display 140 may graphically process and display at least one of a plurality of graphic objects to be distinguished from the remaining graphic objects among the plurality of graphic objects. In particular, in relation to the display 140 according to an embodiment of the present disclosure, a UI for displaying an image for battery reuse will be described in more detail with reference to FIGS. 5A to 11.

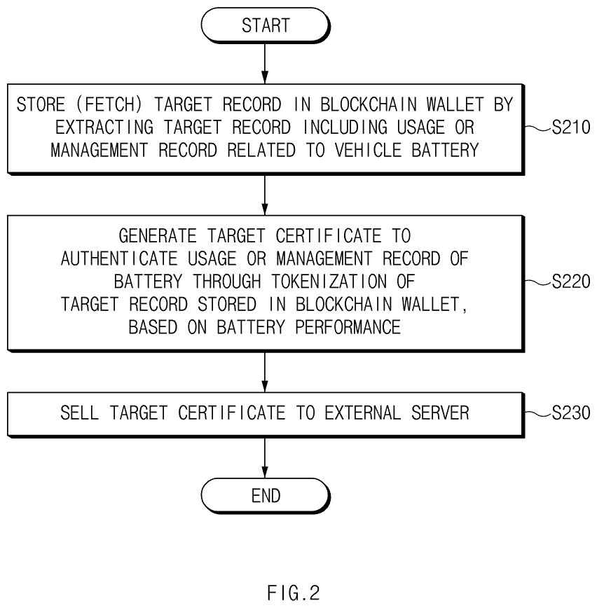

FIG. 2 is a flowchart illustrating a method of managing a battery according to an embodiment of the present disclosure.

In operation S210, a battery management apparatus (e.g., the battery management apparatus 100 of FIG. 1) may store (and fetch) the target record extracted from a vehicle in a blockchain wallet or on a blockchain ledger. For example, the battery management apparatus may extract from the vehicle the target record that includes a usage or management record related to the vehicle battery and is used in whole or in part as the basis for determining whether the battery is reusable. The blockchain wallet may represent an electronic wallet for a blockchain network that may exchange not only the target record, but also information about the party providing the target record and information of the party receiving the target record. In more detail, the blockchain wallet may be a tool that manages a key for authenticating information indicating that the target record is owned by the vehicle user on a blockchain network. That is, the vehicle user may verify access authorization and/or ownership of the target record through the above-mentioned blockchain wallet on the blockchain network. The vehicle user may store the target record including a usage or management record related to the vehicle battery in the blockchain wallet through the battery management apparatus. For reference, in this specification, for convenience of explanation, it is mainly explained that the blockchain wallet is MetaMask, but other blockchain wallets and/or blockchain networks can be used. The operation of storing the target record in the blockchain wallet will be described in detail later with reference FIGS. 5A to 5D.

In operation S220, the battery management apparatus may generate a target certificate to authenticate a usage or management record of the battery through tokenization of the target record stored in the blockchain wallet, such as based on the battery not satisfying a battery performance for operating the vehicle.

For example, the battery management apparatus may generate a target certificate for authenticating a usage or management record of the battery by converting the target record stored in a blockchain wallet into a non-fungible token (NFT). The target certificate may represent an NFT. The non-fungible token may represent a blockchain token with non-fungible information attached. That is, a scheme of generating a non-fungible token may generate a non-fungible token for the digital file described above by assigning separate unique identification information to a digital file (e.g., a usage or management record of a battery) using a blockchain encryption or hashing technology. In particular, the non-fungible token may contain information about the unique identifier of the information contained in a block, so each token may have a unique feature. A non-fungible token may be a certificate to prove the originality, authenticity, and uniqueness of a usage or management record of the battery. Regarding a scheme of generating a non-fungible token, the battery management apparatus may utilize a standard contract (e.g., ERC-20, ERC-721, script on BSV) used, issued, or traded on a blockchain network, such as Ethereum blockchain or BSV network. In some embodiments, part or all of the processing for generating a token and/or executing a smart contract can be performed on a transaction processor or node of the blockchain network at the prompting or request of the processor of the battery management apparatus.

However, a scheme of generating a target certificate for a certificate to prove the originality, authenticity, and uniqueness of a usage or management record of the battery is not limited to the above. For example, the battery management apparatus may obtain authentication data for authenticating the usage or management record of a battery according to a preset authentication scheme. The above-described authentication scheme may include at least one of an authentication scheme using one time password (OTP), an authentication scheme using biometric information about a battery user, an authentication scheme using a public certificate of a battery user, or an authentication scheme using the ID/password of a battery user, or any combination thereof.

In operation S230, the battery management apparatus may sell the target certificate to an external server (e.g., the server 135 in FIG. 1). In detail, the server may purchase a target certificate (e.g., the encrypted target record in FIG. 1) from the battery management apparatus, or purchase the encrypted target record and the battery together. The server may promote the activation of the battery reuse market through blockchain by purchasing licensing rights or ownership of at least one of a target certificate, or a battery related to the target certificate, or any combination thereof, from the battery management apparatus. In addition, the server may determine whether to reuse or disassemble the battery based on the target certificate purchased from the battery management apparatus, thereby solving a problem of disposing of waste batteries due to increased usage of vehicles using batteries.

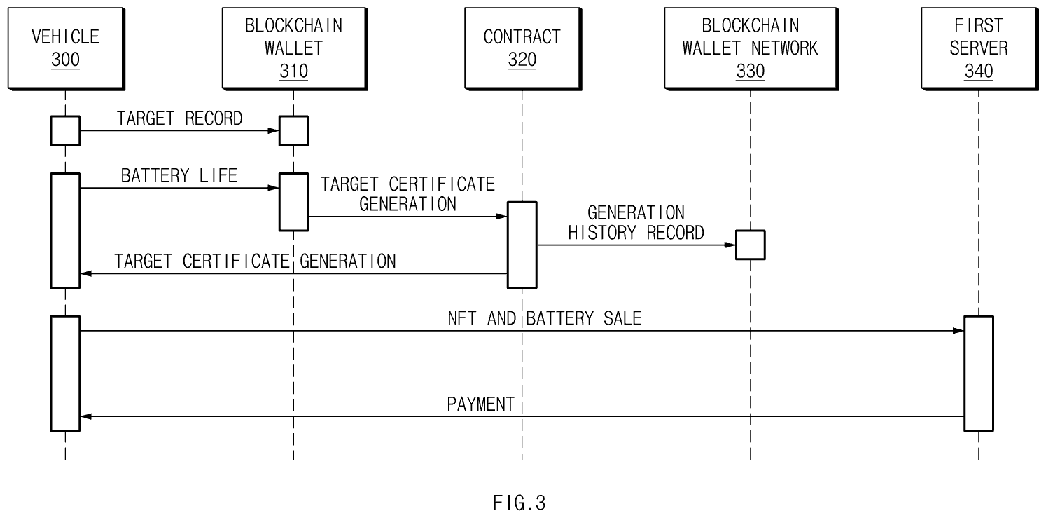

FIG. 3 is a diagram illustrating a method of selling ownership of or access to a target certificate in a battery management apparatus according to an embodiment of the present disclosure.

A battery management apparatus (e.g., the battery management apparatus 100 in FIG. 1) may extract a target record including a usage or management record of a vehicle battery from a vehicle 300. Based on the target record being extracted from the vehicle, the battery management apparatus may store the target record in a blockchain wallet 310.

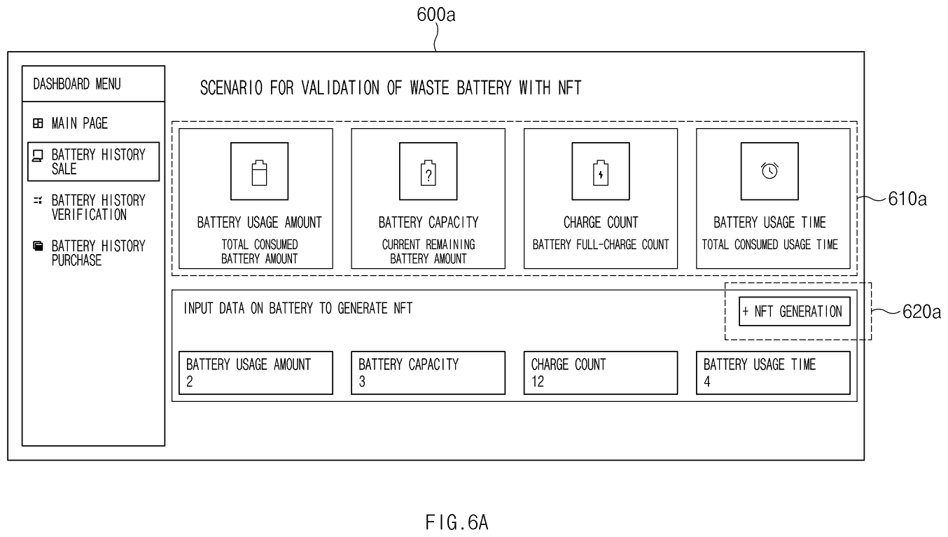

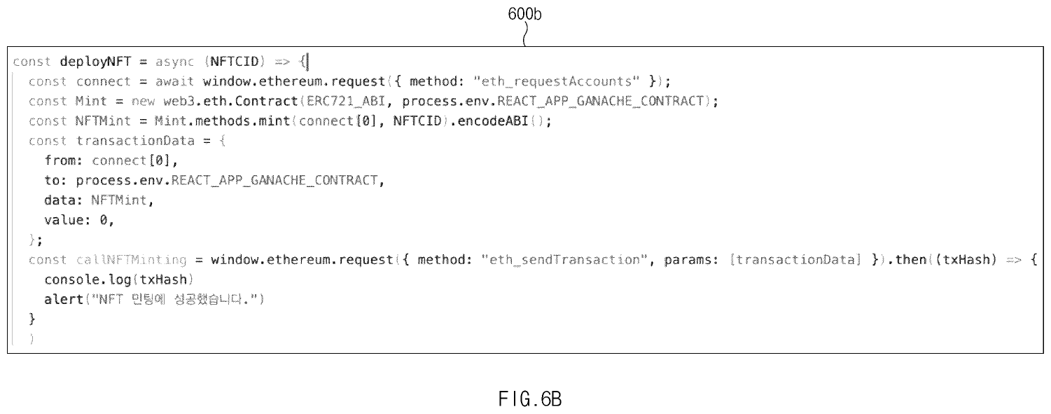

The battery management apparatus may generate a target certificate through tokenization of the target record stored in the blockchain wallet 310 based on the life of the battery of the vehicle 300 being completed (e.g., the battery not meeting the battery performance for operating or driving the vehicle, and the like). In detail, the battery management apparatus may link the blockchain wallet 310 and a contract 320 to generate the target certificate from the target record stored in the blockchain wallet 310. For example, to interwork with the blockchain wallet 310, the battery management apparatus may call the target function of the contract 320, apply the target record to the target function to issue a token related to the target record, and generate a target certificate. The details will be described later with reference to FIGS. 6A and 6B.

The battery management apparatus may record the generation history of the target certificate in a blockchain network 330 based on the target certificate being generated. The battery management apparatus may store the generation history of the target certificate in a block included in the blockchain network 330 and connected in series in a decentralization scheme. Thereafter, the battery management apparatus may transmit the result of generating the target certificate to the user of the vehicle 300 through the result of linking the blockchain wallet 310 and the contract 320 to generate the target certificate.

The battery management apparatus may sell the target certificate to a first server 340, or sell the target certificate and the battery together to the first server 340. For reference, the first server 340 shown in FIG. 3 may be the server shown in FIG. 1 (e.g., the server 135 in FIG. 1). Based on purchasing at least one of the target certificate, the battery related to the target certificate, or any combination thereof, from the battery management apparatus, the first server 340 may pay for it (e.g., a reward for the action of selling the target certificate or a battery) to the vehicle user.

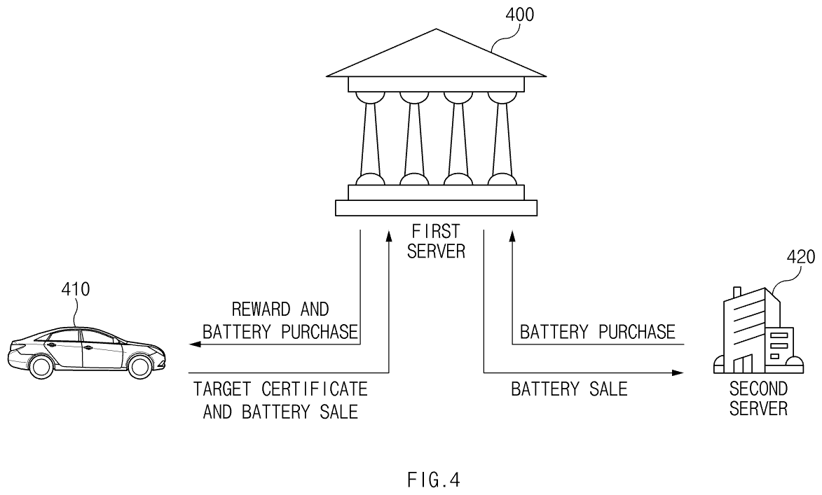

FIG. 4 is a diagram illustrating a vehicle, a first server, and a second server included in a battery management system according to an embodiment of the present disclosure.

A battery management apparatus (e.g., the battery management apparatus 100 of FIG. 1) may generate a target certificate based on the battery not satisfying battery performance for operating a vehicle 410. The target certificate may be used in whole or part as the basis for determining whether the battery is reusable in a first server 400. In detail, the battery management apparatus may sell a target certificate related to the battery of the vehicle 410 to the first server 400. When the target certificate is sold to the first server 400, the battery management apparatus may sell the battery of the vehicle 410 related to the target certificate together. Thus, the user of the vehicle 410 may receive a reward from the first server 400 for selling at least one of the target certificate, or the battery of the vehicle 410 related to the target certificate, or any combination thereof.

However, when the battery does not satisfy the battery performance for operating the vehicle 410, the operation performed by the battery management apparatus is not limited thereto. For example, the battery management apparatus may provide a set or predetermined notification to the user using the vehicle based on the battery not meeting battery performance for operating the vehicle 410. In detail, the battery management apparatus may provide a notification to the user that the life of the battery is completed through an energy management system (EMS) of the vehicle 410.

The first server 400 may represent a server that provides a service for reusing or disassembling the battery of the vehicle 410. In detail, the first server 400 may determine whether to reuse the battery based on purchasing at least one of the target certificate, the battery of the vehicle 410 related to the target certificate, or any combination thereof from the user of the vehicle 410 by the battery management apparatus. For example, the first server 400 may obtain a usage or management record of the battery through the target certificate. The first server 400 may determine whether to reuse the battery by applying the obtained usage or management record of the battery to a predetermined verification model. The detailed operation by which the first server 400 determines whether to reuse the battery will be described later with reference to FIGS. 9A to 9C

A second server 420 may represent a server of an energy storage system (ESS) for reusing a battery (e.g., a used battery, a reused target battery, a waste battery, or the like) that does not satisfy the battery performance for operating the vehicle 410. For example, the second server 420 may receive or purchase a battery from the first server 400 based on the first server 400 determining that the battery is reusable. The second server 420 may use or resell the battery based on the usage or management record of the battery. In detail, the second server 420 may set a grade of the battery based on the usage or management record of the purchased battery. The above-mentioned battery grade may include a plurality of grades depending on the state of the battery (e.g., a reusing target battery) that satisfies a case where battery performance is not satisfied. In addition, the second server 420 may resell the battery purchased from the first server 400 based on the grade of the battery described above.

The second server 420 may receive or purchase the battery whose reuse is determined by the first server 400 based on the target certificate (e.g., target record encrypted through NFT conversion) without performing analysis on the battery. For example, the second server 420 may determine whether to reuse at least one battery to purchase a battery that satisfies the case where battery performance is not satisfied. In particular, the battery that does not satisfy the battery performance may be reused, but depending on the condition, the battery may be disassembled as a waste battery. Therefore, in a situation where there is no operation of the first server 400 (e.g., an operation of determining whether to reuse the battery based on the target certificate), the second server 420 can be requested to determine whether to reuse at least one battery. To the contrary, as the first server 400 determines whether to reuse a battery that satisfies the case where battery performance is not satisfactory, the second server 420 may purchase the battery whose reuse is determined by the first server 400 without performing analysis on the battery.

Referring to FIGS. 5A to 11, the screens 500a to 1100 may be physically or graphically divided. In detail, according to each operation of a device (e.g., the battery management apparatus 100 in FIG. 1), a first server (e.g., the first server 400 in FIG. 4), and a second server (e.g., the second server 420 in FIG. 4), each processor may output the above-described screen to a display. For example, a processor (e.g., the processor 110 in FIG. 1) of an apparatus may combine a screen to be output to the user by operation of the apparatus and a plurality of graphic objects, thereby outputting the combined image to the display (e.g., the display 140 in FIG. 1). Hereinafter, the result screen according to the operation of each of an apparatus, a first server, and a second server will be described in detail in the order of FIGS. 5A to 11 below.

FIG. 5A is a diagram illustrating a screen for storing a target record in a blockchain wallet in a battery management apparatus according to an embodiment of the present disclosure.

A battery management apparatus (e.g., the battery management apparatus 100 of FIG. 1) may store a token related to a target record in a blockchain wallet. For example, according to a user's request, the battery management apparatus may store a token for the target record in a blockchain wallet. The user's request may be received through a graphic object 510a of the screen 500a.

The graphic object 510a may represent an object related to storing a token related to a target record in a blockchain wallet. For example, based on the user's request being received through the graphic object 510a, the battery management apparatus may call a target function of a first standard contract to link the blockchain wallet. The battery management apparatus may apply the target record to the target function of the first standard contract based on the target function of the first standard contract being called and issue the token related to the target record. Thereafter, the battery management apparatus may store the token for the target record in the blockchain wallet. The details will be described in detail later with reference to FIGS. 5B to 5D.

FIG. 5B is a diagram illustrating a portion of a code 500b for storing a token related to a target record of a source level that may be executed in a battery management apparatus in a blockchain wallet. Referring to FIG. 5B, the code 500b includes a code that calls a target function (e.g., approve function) of the first standard contract (e.g., ERC-20). When an operation of calling the approve function is translated into an instruction by a compiler (not shown), the battery management apparatus may apply the target record to the target function to issue a token related to the target record. In other words, the battery management apparatus may obtain permission to use the target record by applying the target record stored in the blockchain wallet to the target function.

FIG. 5C is a diagram illustrating a portion of a code 500c related to a target function of the first standard contract of a source level that may be executed in a battery management apparatus. Referring to FIG. 5C, the code 500c includes a portion of a code related to a target function (e.g., approve function) of a first standard contract (e.g., ERC-20). When an operation that calls an approve function and performs an operation related to the approve function is translated into an instruction by a compiler (not shown), the battery management apparatus may use the owner (e.g., the user of the vehicle) of the token for the target record, the entity (e.g., the address of the contract for the purchase process) that will pay the token for the target record, and the number of tokens for the target record as parameters of the approve function.

FIG. 5D is a diagram illustrating a portion of a code 500d of a source-level target structure that may be executed in a battery management apparatus. Referring to FIG. 5D, the code 500d includes a portion of a code related to the target structure. When an operation calling the target structure is translated into an instruction by a compiler (not shown), the battery management apparatus may apply the target structure to a token related to the target record. For example, the target structure may include at least one of a first factor indicating whether the target record is verified (e.g., shown as verified in the code 500d), a second factor for recognizing the target certificate to be generated from the target record (e.g., shown as tokenID in the code 500d), a third factor for the address where the target record is to be stored in a file system using the IPFS protocol (e.g., shown as tokenURI in the code 500d), or any combination thereof.

Based on a user's request being received through the graphic object 510a, the battery management apparatus may store the token related to the target record in the blockchain wallet through the codes shown in FIGS. 5B to 5D. For reference, in this specification, for convenience of explanation, a framework in which the battery management apparatus stores a token related to a target record in a blockchain wallet will be mainly described as a Sepolia framework.

FIG. 6A is a diagram illustrating a screen for generating a target certificate from a target record in a battery management apparatus according to an embodiment of the present disclosure.

A battery management apparatus (e.g., the battery management apparatus 100 in FIG. 1) may apply a target record to the target function of the second standard contract based on the target function of the second standard contract being called, thereby generating a target certificate. For example, the battery management apparatus may generate the target certificate at the time point at which a user's request is received (e.g., when a user's input is received). The user's request may be received through a graphic object 620a of a screen 600a.

The graphic object 620a may represent an object related to the operation of generating a target certificate from a target record. For example, the battery management apparatus may calculate at least one of a usage amount, a capacity, a number of charging times, or a usage time of a battery, or any combination thereof based on at least one of a voltage, current, or a temperature of the battery, or any combination thereof. For reference, the usage amount, capacity, the number of charging times, and usage time of the battery may be expressed as a graphic object 610a on the screen 600a.

FIG. 6B is a diagram illustrating a portion of a code 600b for generating a target certificate from a target record of a source level that may be executed in a battery management apparatus. Referring to FIG. 6B, the code 600b includes a portion of a code that calls the target function (e.g., mint function) of the second standard contract (e.g., ERC-721). When the operation calling the mint function is translated into an instruction by a compiler (not shown), the battery management apparatus may apply at least one of the usage amount, the capacity, the number of charging times, or the battery usage time of the battery, or any combination thereof to the target record. The battery management apparatus may apply the target record to the target function of the second standard contract based on the target function of the second standard contract being called to convert the token related to the target record into a non-fungible token (NFT), thereby generating a target certificate.

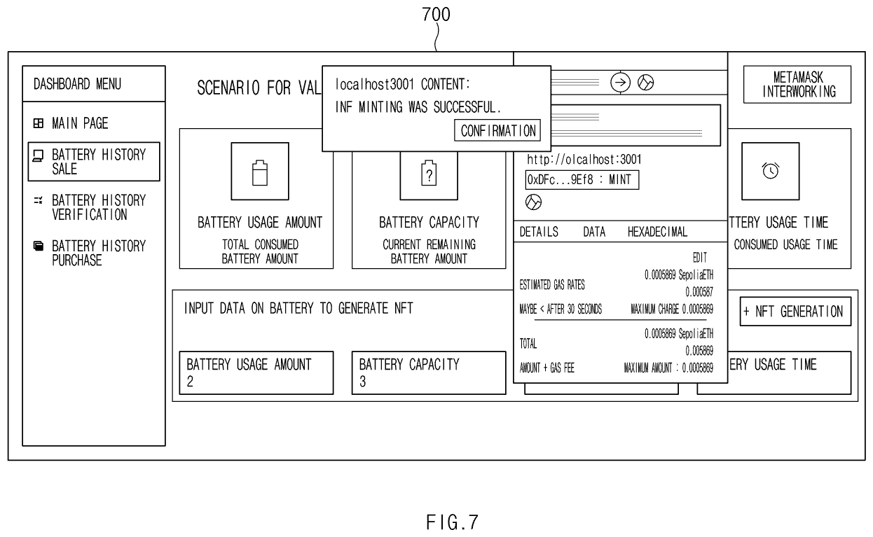

FIG. 7 is a diagram illustrating a screen showing a result of generating a target certificate in a battery management apparatus according to an embodiment of the present disclosure.

A battery management apparatus (e.g., the battery management apparatus 100 in FIG. 1) may provide a screen 700 to a user based on a target certificate being generated according to FIGS. 6A and 6B described above. For example, the screen 700 may express a result of generating a target certificate for authenticating at least one of a usage amount of a battery, a capacity of the battery, or the number of charging times of the battery, or any combination thereof through NFT. For reference, an operation of generating a target certificate from a target record may be referred to as performing NFT minting. Therefore, the battery management apparatus may provide the screen 700 to a user indicating that NFT minting is successful based on the target certificate being generated.

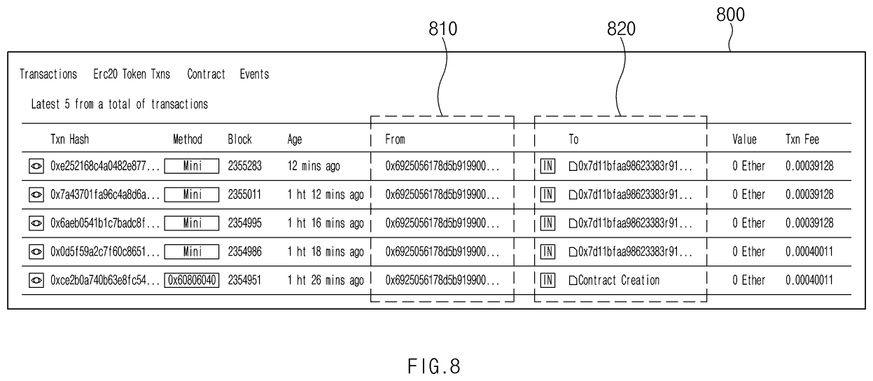

FIG. 8 is a diagram illustrating a screen displaying at least one target certificate in a battery management apparatus according to an embodiment of the present disclosure.

A battery management apparatus (e.g., the battery management apparatus 100 in FIG. 1) may generate an address of a smart contract for generating the address of a blockchain wallet and a target certificate to prove that the target certificate is generated. For example, the smart contract may include contents related to an operation of storing a target record in a blockchain wallet and an operation of tokenizing a target record. In detail, the battery management apparatus may provide the user with a screen 800 for verifying that the target certificate is generated through a graphic object 810 and a graphic object 820 of a screen 800. For reference, in this specification, for convenience of explanation, the screen 800 is mainly described as a Sepolia Ether scan screen.

The graphic object 810 may include addresses of blockchain wallets. For example, the address of the blockchain wallet may indicate the address of the blockchain wallet (e.g. Metamask) where the target record is stored. The graphic object 820 may include addresses of a smart contract for generating a target certificate. For example, the address of a smart contract may include an address of a block in which a record of at least one of a record of issuing a token for a target record, a record of storing the target record in a blockchain wallet, or a record of generating a target certificate through non-fungible tokenization of the token for the target record, or any combination thereof is stored.

FIG. 9A is a diagram illustrating a screen for verifying a usage or management record of a battery in a first server included in a battery management system according to an embodiment of the present disclosure.

A first server (e.g., the first server 400 in FIG. 4) may verify a usage or management record of a battery included in an encrypted target record (e.g., a target certificate) according to a user request. For example, the user request may be received through a graphic object 910a on a screen 900a.

The graphic object 910a may represent an object related to verifying the usage or management record of the battery included in the target certificate. For example, based on a user request being received through the graphic object 910a, the first server may load the target address where the target certificate will be stored in a file system using the IPFS protocol. The first server may verify the usage or management record of the battery included in the target certificate based on the target address being loaded. The operation in which the first server verifies the usage or management record of the battery will be described in detail later through the codes shown in FIGS. 9B and 9C.

FIG. 9B is a diagram illustrating a portion of a code 900b for verifying a target certificate of a source level that may be executed on a first server included in a battery management system according to an embodiment of the present disclosure. Referring to FIG. 9B, the code 900b includes a portion of a code for the first server to access the address and obtain data using IPFS which is a distributed file storage system. For reference, the IPFS may be operated in such a manner that information is stored in a distributed form on a blockchain-based network and shared over the Internet. In particular, the IPFS may support information through a smart contract about a user of a target certificate, such as a seller and a buyers, in a blockchain-based network. When the operation included in the code 900b is translated into an instruction by a compiler (not shown), the first server may perform verification on the usage or management record of the battery.

FIG. 9C is a diagram illustrating a portion of a code 900c for completing verification of a target certificate of a source level that may be executed on a first server included in a battery management system according to an embodiment of the present disclosure. Referring to FIG. 9C, the code 900c includes a portion of a code for the first server to complete the verification of the usage or management record of the battery included in the target certificate based on the loaded target address.

Based on the first server verifying the usage or management record of the battery through the codes shown in FIGS. 9B and 9C, the first server may apply the usage or management record of the battery to a predetermined verification model to determine whether to reuse the battery.

As an example, a verification model that determines whether to reuse a battery may include a neural network. The neural network may include a plurality of layers, and each layer may include a plurality of nodes. A node may have a node value determined based on an activation function. A node in an arbitrary layer may be connected to a node (e.g., another node) in another layer through a link (e.g., a connection edge) with a connection weight. The node value of a node may be propagated to other nodes through links. In the inference operation of a neural network, node values may be forward propagated from the previous layer to the next layer. The neural network may be at least one combination of a deep neural network (DNN), a convolutional neural network (CNN), a U-Net for image segmentation (U-net), a recurrent neural network (RNN), a restricted boltzmann machine (RBM), a deep belief network (DBN), a bidirectional recurrent deep neural network (BRDNN), or a deep Q-network, or any combination thereof, but is not limited to the above examples.

In particular, the learned verification model may represent a model learned through machine learning, and may be a learned machine learning model that outputs a training output (e.g., information on whether to reuse the battery) from a training input (e.g., a usage or management records on a battery). Regarding verification models, a machine learning model (e.g., a learned verification model) may be generated through machine learning. For example, a learning algorithm may include supervised learning, unsupervised learning, semi-supervised learning, or reinforcement learning, but is not limited to the above examples.

FIG. 10A is a diagram illustrating a screen for purchasing a battery from a battery management apparatus in a first server included in a battery management system according to an embodiment of the present disclosure.

A first server (e.g., the first server 400 of FIG. 4) may purchase an encrypted target record (e.g., a target certificate) from a battery management apparatus (e.g., the battery management apparatus 100 of FIG. 1), or purchase the target certificate and the battery together. The purchase of the target certificate by the first server may be expressed through a screen 1000a. A detailed operation of purchasing a target certificate from a battery management apparatus by the first server will be described later through a code shown in FIG. 10B.

FIG. 10B is a diagram illustrating a portion of a code 1000b for purchasing a target certificate of a source-level that may be executed on a first server included in a battery management system according to an embodiment of the present disclosure. Referring to FIG. 10B, the code 1000b includes a portion of a code that calls a target function (e.g., a purchase function) of a third standard contract (e.g., ERC-721). When the operation of calling the purchase function is translated into an instruction by a compiler (not shown), the first server may call the target function of the third standard contract.

Based on the target function of the third standard contract being called, the first server may purchase a battery from a battery management apparatus by applying, to the target function of the third standard contract, at least one of an address for recognizing a target certificate, an address for purchasing a battery, or an address of a smart contract for selling a battery, or any combination thereof. For reference, in FIG. 10B, the third standard contract is mainly described as ERC-721, but is not limited thereto. For example, the third standard contract may represent a contract for ERC-20 or BSV, for example.

FIG. 11 is a diagram illustrating a screen showing a result of purchasing a battery from a battery management apparatus in a first server included in a battery management system according to an embodiment of the present disclosure.

A first server (e.g., the first server 400 in FIG. 4) may purchase an encrypted target record (e.g., a target certificate) from a battery management apparatus (e.g., the battery management apparatus 100 in FIG. 1). The details of the first server purchasing the target certificate from the battery management apparatus may be expressed on a screen 1100. For example, the screen 1100 may display battery details related to the target certificate purchased by the first server. For reference, in this specification, for convenience of explanation, the screen 1100 of FIG. 11 may display information about a usage amount of a battery, a capacity of the battery, the number of charging times of the battery, and a usage time of the battery calculated based on at least one of a voltage of the battery, a current of the battery, or a temperature of the battery, or any combination thereof.

Based on the first server purchasing a target certificate from the battery management apparatus and determines that the battery is reusable by verifying the usage or management record of the battery, a second server (e.g., the second server 420 in FIG. 4) may receive or purchase a battery from the first server, and use or resell the battery based on the usage or management record of the battery. In particular, the second server may receive or purchase a battery whose reuse is determined by the first server based on the target certificate, which is an encrypted target record, without performing analysis on the battery.

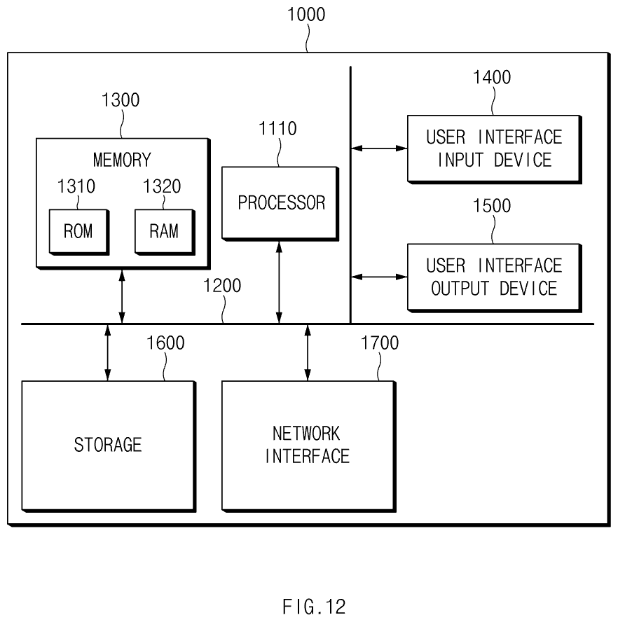

FIG. 12 is a diagram illustrating a computing system related to a battery management apparatus, a system including the same, and a method thereof according to embodiments of the present disclosure.

Referring to FIG. 12, a computing system 1000 related to a battery management apparatus, a system including the same, and a method thereof may include at least one processor 1110, connected through a system bus 1200, a memory 1300, a user interface input device 1400, a user interface output device 1500, storage 1600, and a network interface 1700, which are connected through a bus 1200, any combination of or all of which may be in plural or may include plural components thereof.

The processor 1110 may be a central processing unit (CPU) or a semiconductor device that processes instructions stored in the memory 1300 and/or the storage 1600. A storage medium can include one of or both of the memory 1300 and the storage 1600, which may include various volatile or nonvolatile storage media. For example, the memory 1300 may include a read only memory (ROM) and a random access memory (RAM).

Accordingly, the processes of the method or algorithm described in relation to the embodiments of the present disclosure may be implemented directly by hardware executed by the processor 1110, a software module, or any combination thereof. The software module may reside in a storage medium (that is, the memory 1300 and/or the storage 1600), such as a RAM memory, a flash memory, a ROM memory, an EPROM memory, an EEPROM memory, a register, a hard disk, a detachable disk, or a CD-ROM.

The example storage medium can be coupled to the processor 1110, and the processor 1110 may read information from the storage medium and may write information in the storage medium. In another method, the storage medium may be integrated with the processor 1110. The processor and the storage medium may reside in an application specific integrated circuit (ASIC). The ASIC may reside in a user terminal. In another method, the processor and the storage medium may reside in the user terminal as an individual component.

The above description is a simple example of the technical spirit of the present disclosure, and the present disclosure may be variously corrected and modified by those skilled in the art to which the present disclosure pertains without departing from the present disclosure.

The embodiments described above may be realized by hardware elements, software elements, and/or combinations thereof. For example, the devices and components illustrated in the example embodiments of the present disclosure may be implemented in one or more general-use computers or special-purpose computers, such as a processor, a controller, an arithmetic logic unit (ALU), a digital signal processor, a microcomputer, a field programmable gate array (FPGA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It can be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor or distributed processing.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media, or may be stored in a decentralized distributed storage and/or blockchain ledger.

The methods according to the above-described example embodiments may be implemented with program instructions that may be executed through various computer schemes and may be recorded in computer-readable media. The media may also include, alone or in combination with the program instructions, data files, data structures, and the like. The program instructions recorded in the media may be designed and configured specially for the example embodiments or other systems. Computer-readable media can include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions can include both machine codes, such as produced by a compiler, and higher level codes that may be executed by the computer using an interpreter.

The described hardware devices may be configured to act as one or more software modules to perform the operations of the above-described example embodiments of the inventive concept, or vice versa.

Some advantages of a battery management apparatus, a system including the same, and a method thereof according to the embodiments of the present disclosure will be described as follows.

According to at least one of the embodiments of the present disclosure, it is possible to provide a reward to users who sell expired batteries by encrypting records related to the vehicle batteries and selling them to an external server, promote the revitalization of the battery reuse market and the reuse market of waste battery parts based on records about batteries, and enhance the security of battery records through blockchain,

According to at least one of the embodiments of the present disclosure, it is possible to solve social issues related to used battery disposal due to increased use of electric vehicles by purchasing encrypted target records and batteries together, and provide efficiency and convenience in battery inspection through battery records.

According to at least one of the embodiments of the present disclosure, it is possible to reduce the cost of recycling battery analysis through batteries with transparent management history by receiving or purchasing batteries based on a battery being determined to be reusable.

Various advantages that are directly or indirectly understood through the present disclosure may be provided.

While a few example embodiments have been shown and described with reference to the accompanying drawings, it can be apparent to those skilled in the art that various modifications and variations may be made from the foregoing descriptions. For example, adequate effects may be achieved even when the foregoing processes and methods are carried out in different order than described above, and/or the aforementioned elements, such as systems, structures, devices, or circuits, are combined or coupled in different forms and modes than as described above or be substituted or switched with other components or equivalents.

Thus, it is intended that the present disclosure covers other realizations and other embodiments of the present disclosure within the scope of the appended claims and their equivalents.

Therefore, the disclosed embodiments of the present disclosure do not necessarily limit the technical spirit of the present disclosure but are illustrative, and the scope of the technical spirit of the present disclosure is not necessarily limited by the embodiments of the present disclosure. The scope of the present disclosure can be construed by the claims, and it can be understood that all the technical spirits within the equivalent range can fall within the scope of the present disclosure.

What is claimed is:

1. A battery management apparatus, the apparatus comprising:
one or more processors; and
a non-transitory storage medium storing computer-readable instructions that, when executed by the one or more processors, enable the one or more processors to:
extract a target record including a usage or management record related to a battery of a vehicle from the vehicle,
encrypt the target record in response to the battery not meeting a battery performance for operating a vehicle, and
transmit the encrypted target record to an external server, the encrypted target record including information that can be used in whole or in part to determine whether the batter is available for reuse.

2. The apparatus of claim 1, wherein the instructions further enable the one or more processors to:
store and fetch the target record extracted from the vehicle on a blockchain wallet; and
generate a target certificate for authenticating the usage or management record related to the battery by tokenizing the target record stored in the blockchain wallet.

3. The apparatus of claim 2, wherein the instructions further enable the one or more processors to:
call a target function of a first standard contract to link with the blockchain wallet;
apply the target record to the target function of the first standard contract based on the target function of the first standard contract being called;
issue a token related to the target record; and
store the token related to the target record in the blockchain wallet.

4. The apparatus of claim 2, wherein the instructions further enable the one or more processors to:
generate a target structure including one of or any combination of a first factor for indicating whether the target record is verified, a second factor for recognizing the target certificate to be generated from the target record, and a third factor for an address where the target record is stored in a file system using an interplanetary file system protocol; and
apply the target structure to a token related to the target record.

5. The apparatus of claim 2, wherein the instructions further enable the one or more processors to:
calculate one of or any combination of a usage amount of the battery, a capacity of the battery, a number of charging times of the battery, and a usage time of the battery, based on one of or any combination of a voltage of the battery, a current of the battery, and a temperature of the battery;
apply the one of or any combination of the usage amount of the battery, the capacity of the battery, the number of charging times of the battery, and the usage time of the battery, to the target record;
call a target function of a second standard contract to tokenize the target record into a non-fungible token; and
apply the target record to the target function of the second standard contract based on the target function of the second standard contract being called and generate the target certificate, wherein the usage or management record related to the battery includes the one of or any combination of the voltage of the battery, the current of the battery, and the temperature of the battery, based on one of or both of a charging time point of the battery and a reception time point of a user input.

6. The apparatus of claim 2, wherein the instructions further enable the one or more processors to generate an address of the blockchain wallet and an address of a smart contract for generating the target certificate, wherein the smart contract includes content regarding an operation of storing the target record in the blockchain wallet and an operation of tokenizing the target record.

7. A battery management system, the system comprising:
a first server;
a second server; and
a battery management apparatus configured to extract a target record including a usage or management record related to a battery of a vehicle from the vehicle, and
encrypt the target record and send the encrypted target record to the first server when the battery does not meet a battery performance for operating the vehicle,
wherein the first server is configured to:
accept the encrypted target record from the battery management apparatus, or accept the encrypted target record and request shipment of the battery;
determine whether to reuse the battery based on the encrypted target record; and
in response to determining that the battery is reusable, send an ownership transfer of the battery to the second server in response to a request from the second server.

8. The system of claim 7, wherein the battery management apparatus is further configured to:
store and fetch the target record extracted from the vehicle in a blockchain wallet; and
generate a target certificate for authenticating the usage or management record related to the battery by tokenizing the target record stored in the blockchain wallet.

9. The system of claim 7, wherein the first server is further configured to:
load a target address where the encrypted target record is to be stored in a file system using an interplanetary file system protocol;
verify the usage or management record related to the battery included in the encrypted target record based on the target address; and
apply the usage or management record related to the battery to a verification model to determine whether to reuse the battery.

10. The system of claim 7, wherein the first server is further configured to:
call a target function of a third standard contract; and
apply one of or any combination of an address for recognizing the encrypted target record, an address for purchasing the battery, and an address for a smart contract for selling the battery, to the target function of the third standard contract based on the target function of the third standard contract being called.

11. The system of claim 7, wherein the second server is configured to:
receive ownership transfer information of the battery from the first server based on the first server determining that the battery is reusable; and
designate the battery as available for use or resell the battery based on the usage or management record regarding the battery.

12. The system of claim 7, wherein the second server is configured to receive ownership transfer information of the battery for which reusability was determined by the first server based on the encrypted target record without performing analysis on the battery.

13. The system of claim 7, wherein the battery management apparatus is further configured to:
provide a notification to a user using the vehicle when the battery does not meet the battery performance for operating the vehicle; and
extract the target record from the vehicle based on one of or both of a time point of receiving a request from the user of the vehicle and a time interval.

14. The system of claim 13, wherein the target record is used for regular or irregular inspection of the vehicle.

15. A battery management method, the method comprising:
extracting a target record including a usage or management record related to a battery for a vehicle;
encrypting the target record;
sending the encrypted target record to a first server in response to determining that the battery not meeting a battery performance for operating the vehicle;
acquiring the encrypted target record;
determining whether to reuse the battery based on the encrypted target record;
providing the battery in response to the battery being determined to be reusable;
providing a notification to a user using the vehicle in response to the battery not meeting the battery performance for operating the vehicle;
extracting the target record from the vehicle based on one of or both of a time point of receiving a request from the user of the vehicle and a time interval; and
using the target record for regular or irregular inspection of the vehicle.

16. The method of claim 15, further comprising:
storing and fetching the target record extracted from the vehicle in a blockchain wallet; and
generating a target certificate for authenticating the usage or management record related to the battery by tokenizing the target record stored in the blockchain wallet.

17. The method of claim 15, further comprising:
loading a target address where the encrypted target record is stored in a file system using an interplanetary file system protocol;
verifying the usage or management record related to the battery included in the encrypted target record based on the target address; and
applying the usage or management record related to the battery to a verification model to determine whether to reuse the battery.

18. The method of claim 15, further comprising:
calling a target function of a third standard contract; and
applying one of or any combination of an address for recognizing the encrypted target record, an address for recognizing a second server purchasing the battery, and an address of a smart contract for selling the battery, to the target function of the third standard contract based on the target function of the third standard contract being called.

19. The method of claim 15, further comprising:
receiving or purchasing the battery based on determining that the battery is reusable;
using or reselling the battery based on the usage or management record regarding the battery; and
receiving or purchasing the battery in reliance on a prior determination that the battery is reusable.

20. A server for providing a battery service, the server comprising:
one or more processors; and
a storage medium storing computer-readable instructions that, when executed by the one or more processors, enable the one or more processors to:
obtain a target record including a usage or management record related to a battery for a vehicle, the target record being encrypted,
verify the usage or management record related to the battery included in the encrypted target record based on a target address on a file system using an interplanetary file system protocol based on obtaining the encrypted target record,
apply the usage or management record related to the battery to a verification model to determine whether to reuse the battery based on the verifying of the usage or management record related to the battery, and
determining usability of the battery corresponding to the encrypted target record based on the battery being reusable in response to a request for the battery.
